(19) United States
(12) Patent Application Publication
(10) Pub. No.: US 2026/0270286 A1
(43) Pub. Date: Sep. 10, 2026

(54) SECRETLESS REMOTE ACCESS TO TARGET RESOURCES USING A LOCAL SECURITY AGENT

(71) Applicant: CyberArk Software Ltd., Petach-Tikva (IL)

(72) Inventors: Arthur BENDERSKY, Tel Aviv (IL); Shay TEVET, Petach-Tikva (IL)

(73) Assignee: CyberArk Software Ltd., Petach-Tikva (IL)

(21) Appl. No.: 19/665,267

(22) Filed: May 1, 2026

Related U.S. Application Data
(63) Continuation-in-part of application No. 17/368,136, filed on Jul. 6, 2021, now Pat. No. 12,621,331.
Application No. 17/368,136 is a continuation-in-part of application No. 17/097,809, filed on Nov. 13, 2020, now Pat. No. 11,552,943.

(51) Int. Cl. H04L 9/40

(52) U.S. Cl. CPC H04L 63/1433; H04L 63/108; H04L 63/1416

(57) ABSTRACT

Disclosed embodiments relate to systems and methods for detecting and addressing security risks in remote native access sessions. Techniques include establishing, by a security agent on a client machine, a local connection with a native access client on the client machine; identifying, via the local connection, a connection request for a remote native access session, the connection request being initiated by the native access client; obtaining, based on the connection request, a validated credential of a user associated with the connection request, the validated credential having been received from a remote management agent; generating a modified credential based on the validated credential, the modified credential being in a format associated with the native access client; and providing the modified credential to the native access client for initiating the remote native access session.

### CROSS REFERENCES TO RELATED APPLICATIONS

This application is a continuation-in-part of U.S. patent application Ser. No. 17/368,136, filed Jul. 6, 2021, which is a continuation-in-part of U.S. patent application Ser. No. 17/097,809, filed Nov. 13, 2020, now issued as U.S. Pat. No. 11,552,943.

### BACKGROUND

### Technical Field

The present disclosure relates generally to cybersecurity and, more specifically, to techniques for facilitating remote connections using local security agents.

### Background Information

Organizations and individuals increasingly use remote network connections for accessing secure files and other network resources. For example, many organizations allow individuals to work collaboratively from different offices, from home office locations, or while travelling. As another example, individuals may use cloud-based servers for storing electronic files and may access these files through a remote connection. Thus, these remote connections provide improved flexibility, allowing users to access a network remotely as if their device was connected to the network directly. Although advantageous, these remote connections may present security vulnerabilities and are common targets for malicious actors to gain access to the secure network or user data.

Some existing techniques, such as virtual private networks (VPNs), require the installation of VPN clients, which can be cumbersome for users and often lead to increased operating expenditures for organizations. Further, VPNs often do not discriminate among target resources, and instead provide users with full access to the network. For this reason, VPN clients are common attack points for malicious users, who may target security vulnerabilities to gain access to secure networks and harvest user credentials or other sensitive data. Further, such VPN clients often require users to enter passwords specific to the VPN service, which increases the risk of credentials theft and deteriorates the user's experience. Other techniques, such as HTML5 gateway solutions, do not require the installation of VPN clients, but equally provide a poor user experience by requiring a browser-based session, rather than a native desktop client.

Some remote desktop gateway techniques allow for passwordless or multi-factor authentication, however, additional passwords may be required to access a particular target resource. Further, these remote desktop gateways often require a user to identify details of a target server (such as IP addresses, or port configurations), a domain username, or other sensitive information, which may create an attack vector for malicious actors.

Accordingly, in view of these and other deficiencies in existing techniques, technological solutions are needed for securely establishing passwordless and native remote access sessions. In particular, solutions should advantageously allow for the sessions to be established without requiring separate credentials. Further, technological solutions may provide local security agents to act as a broker for establishing Remote Desktop Protocol (RDP), Secure Shell (SSH), or similar connections in a transparent manner.

### SUMMARY

The disclosed embodiments describe non-transitory computer readable media, systems, and methods for securely establishing secretless and remote native access sessions. For example, in an embodiment, a non-transitory computer readable medium may include instructions that, when executed by at least one processor, cause the at least one processor to perform operations for securely establishing secretless and remote native access sessions. The operations may comprise identifying, by a security agent on a client machine, a connection request for a remote native access session, the connection request being initiated by a native access client on the client machine; initiating a connection with a remote management agent; providing, to the remote management agent via the connection, context information and a target resource for the remote native access session; receiving, from the remote management agent, parameter information for the remote native access session, the parameter information being generated by the remote management agent based on the context information and the target resource; modifying session information associated with the connection request based on the received parameter information; and initiating the remote native access session based on the modified session information.

According to a disclosed embodiment, the operations may further comprise accepting the connection request by the security agent.

According to a disclosed embodiment, the operations may further comprise extracting, by the security agent, a target address for the target resource from a data structure.

According to a disclosed embodiment, the data structure may be stored at the remote management agent.

According to a disclosed embodiment, the remote management agent may be configured to route the remote native access session to the target resource based on the modified session information.

According to a disclosed embodiment, modifying the session information may include replacing the original session parameters in the session information with the received parameter information.

According to a disclosed embodiment, the remote management agent may be configured to accept the session information based on the parameter information in the modified session information.

According to a disclosed embodiment, the session information may include a Remote Desktop Protocol ClientInfo payload.

According to a disclosed embodiment, the native access client may be a Microsoft™ Terminal Services Client.

According to a disclosed embodiment, the connection request may include a remote access protocol file.

According to a disclosed embodiment, the remote access protocol file may be a Remote Desktop Protocol connection file.

According to another disclosed embodiment, there may be a computer-implemented method for securely establishing secretless and remote native access sessions. The method may comprise identifying, by a security agent on a client machine, a connection request for a remote native access session, the connection request being initiated by a native access client on the client machine; initiating a connection with a remote management agent; providing, to the remote management agent via the connection, context information and a target resource for the remote native access session; receiving, from the remote management agent, parameter information for the remote native access session, the parameter information being generated by the remote management agent based on the context information and the target resource; modifying session information associated with the connection request based on the received parameter information; and initiating the remote native access session based on the modified session information.

According to a disclosed embodiment, initiating the remote native access session may include forwarding the modified session information to the remote management agent.

According to a disclosed embodiment, the method may further comprise relaying session information to the native access client during the remote native access session.

According to a disclosed embodiment, the method may further comprise extracting the context information and the target resource by the security agent.

According to a disclosed embodiment, the context information and the target resource may be extracted from the connection request.

According to a disclosed embodiment, the remote management agent may be implemented as a cloud-based agent.

According to a disclosed embodiment, the method may further comprise monitoring the remote native access session by the security agent.

According to a disclosed embodiment, the method may further comprise performing a control action by the security agent based on an anomaly detected during the monitoring.

According to a disclosed embodiment, the control action may include terminating the remote native access session.

According to another disclosed embodiment, a non-transitory computer readable medium may include instructions that, when executed by at least one processor, cause the at least one processor to perform operations for securely establishing secretless and remote native access sessions. The operations may comprise establishing, by a security agent on a client machine, a local connection with a native access client on the client machine; identifying, via the local connection, a connection request for a remote native access session, the connection request being initiated by the native access client; obtaining, based on the connection request, a validated credential of a user associated with the connection request, the validated credential having been received from a remote management agent; generating a modified credential based on the validated credential, the modified credential being in a format associated with the native access client; and providing the modified credential to the native access client for initiating the remote native access session.

According to a disclosed embodiment, the operations may further comprise verifying an active session for the user associated with the remote management agent.

According to a disclosed embodiment, obtaining the validated credential may include retrieving the validated credential from a local storage.

According to a disclosed embodiment, the local storage may include a storage device on the client machine.

According to a disclosed embodiment, the validated credential may have been stored in the local storage by the security agent during a prior remote native access session.

According to a disclosed embodiment, obtaining the validated credential may include requesting the validated credential from the remote management agent.

According to a disclosed embodiment, the remote management agent may be configured to issue the validated credential based on an active session for the user associated with the remote management agent.

According to a disclosed embodiment, the validated credential may be associated with a time-based restriction.

According to a disclosed embodiment, the connection request may be initiated by the user using the client machine.

According to a disclosed embodiment, the native access client may be a Secure Shell (SSH) client.

According to another disclosed embodiment, there may be a computer-implemented method for securely establishing secretless and remote native access sessions. The method may comprise establishing, by a security agent on a client machine, a local connection with a native access client on the client machine; identifying, via the local connection, a connection request for a remote native access session, the connection request being initiated by the native access client; obtaining, based on the connection request, a validated credential of a user associated with the connection request, the validated credential having been received from a remote management agent; generating a modified credential based on the validated credential, the modified credential being in a format associated with the native access client; and providing the modified credential to the native access client for initiating the remote native access session.

According to a disclosed embodiment, the method may further comprise: determining, by the security agent, that the validated credential has expired; and terminating the remote native access session.

According to a disclosed embodiment, the remote management agent may be implemented as a cloud-based agent.

According to a disclosed embodiment, the native access client may be configured to initiate the remote native access session based on the modified credential.

According to a disclosed embodiment, the native access client may be configured to initiate the remote native access session via a proxy agent associated with the remote management agent.

According to a disclosed embodiment, the proxy agent may be configured to route the remote native access session to a target resource.

According to a disclosed embodiment, obtaining the validated credential may include retrieving the validated credential from a local storage.

According to a disclosed embodiment, the local storage may include a storage device on the client machine.

According to a disclosed embodiment, obtaining the validated credential may include requesting the validated credential from the remote management agent.

According to a disclosed embodiment, the remote management agent may be configured to issue the validated credential based on an active session for the user associated with the remote management agent.

Aspects of the disclosed embodiments may include tangible computer software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for providing native remote access to target resources, consistent with the disclosed embodiments.

FIG. 2 is a block diagram showing an example computing system, consistent with the disclosed embodiments.

FIG. 3 is a block diagram illustrating an example process for providing native remote access to target resources, consistent with the disclosed embodiments.

FIG. 4 illustrates an example user interface for selecting an account, consistent with the disclosed embodiments.

FIG. 5 is a flowchart depicting an example process for securely establishing secretless and remote native access sessions, consistent with the disclosed embodiments.

FIG. 6 is a flowchart depicting an example process for detection of security risks based on secretless connection data, consistent with the disclosed embodiments.

FIG. 7 is a block diagram illustrating an example process for providing native RDP access to target resources, consistent with the disclosed embodiments.

FIG. 8 is a block diagram illustrating an example process for providing native SSH access to target resources, consistent with the disclosed embodiments.

FIG. 9 is a flowchart illustrating an example process for providing native RDP access to target resources by a local security agent, consistent with the disclosed embodiments.

FIG. 10 is a flowchart illustrating an example process 1000 for providing native SSH access to target resources by a local security agent, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for securely establishing secretless and remote native access sessions described herein overcome several technological problems relating to security, efficiency, and functionality in the fields of cybersecurity and remote network access. In particular, the disclosed embodiments provide techniques for establishing secure remote access sessions in a passwordless manner using native desktop clients. As discussed above, many current remote access techniques present security vulnerabilities and inefficiencies both for users and for organizations. For example, virtual private networks (VPNs) and other connections often create attack vectors for malicious actors. In particular, VPN and other clients often use credentials, such as passwords, when establishing the connection, which may unnecessarily expose these credentials to attackers. Similarly, some techniques include sensitive information about the client or the host network in communications establishing the connection, which may also create vulnerabilities. Further, VPN clients and other techniques often allow broad access to a network, which may increase the ability of attackers to access sensitive information or escalate privileges in the network.

The disclosed embodiments provide technical solutions to these and other problems with current techniques. In particular, the disclosed techniques do not require passwords or other credentials to be stored on the client device, or to be transmitted by the client to the target network system, thereby improving security in the network. Further, the disclosed techniques allow a remote access session to be established without identifying a particular target resource and without transmitting usernames or other sensitive information associated with the client during the connection phase. Rather, this information may be provided after the connection has been established and once a user has been authenticated. Moreover, the scope of access that a user may be granted can be narrowly tailored based on permissions associated with the user or the current access requirements of the user. For these, and other reasons that will be apparent to those skilled in the art, the disclosed techniques provide improved security over existing techniques.

Further, some of the disclosed techniques may not require a dedicated agent or client to be installed on a client device for establishing the secure connection other than software components that are native to the device and/or the operating system. For example, the remote access may be established using a standard remote desktop protocol, without the need for a VPN client, a web-based portal, or other non-native software. This not only improves the experience for the user, but can provide increased flexibility in the types of devices that can access the network, and can also reduce overhead costs associated with maintenance and troubleshooting of a dedicated client. Alternatively or additionally, some of the disclosed embodiments may provide a local security agent, which may enable secure, transparent access over RDP, SSH, and/or other connection protocols without changing the user's normal workflow. The agent may be optimized to broker sessions locally, for example, by obtaining approved runtime access artifacts from a security service, and route traffic through this controlled service, thus improving efficiency, user experience, and security for certain connection types.

The disclosed techniques also solve technological problems in the areas of detection of malicious activity and identifying anomalous activity. As discussed further below, a wide variety of data may be collected from a connection session (e.g., an RDP session). This data may come from the connection session itself, or from the user's computing device (e.g., mobile device, computer, etc.). The data may then be used to uniquely profile individual users and their activity. If an anomaly is detected between a user's regular or typical activity and observed activity, an inference about potentially malicious or problematic activity may be made. As discussed below, based on this determination various security control operations may be performed, such as closing the remote session, limiting a number of permitted remote sessions for a user, triggering an alert, recording or auditing data associated with the session, commencing a video recording of the session or a user, or various other operations.

Reference will now be made in detail to the disclosed embodiments, examples of which are illustrated in the accompanying drawings.

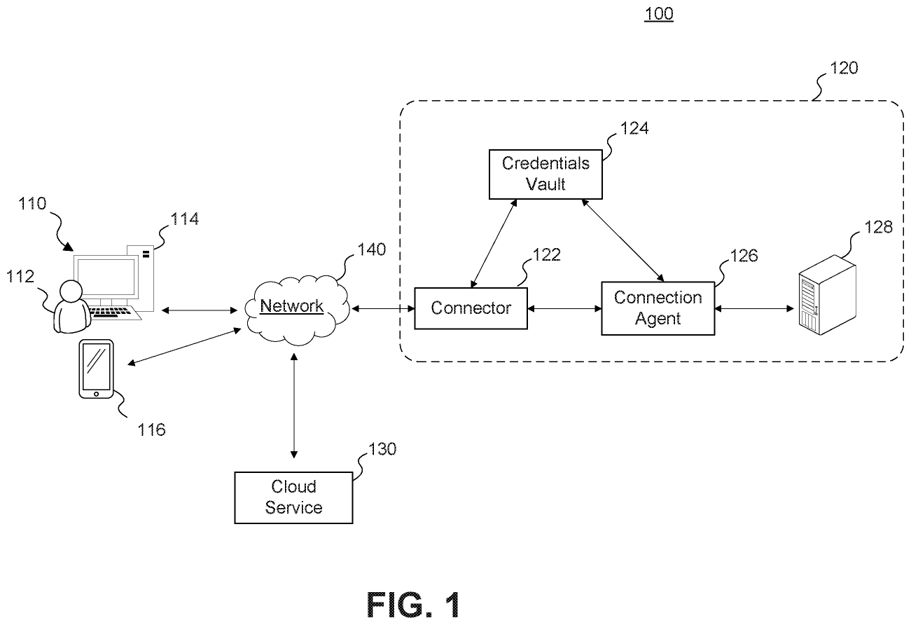

FIG. 1 illustrates an example system environment 100 for providing native remote access to target resources, consistent with the disclosed embodiments. System environment 100 may include one or more client identities 110, one or more mobile devices 116, a client system 120, and one or more cloud services 130, as shown in FIG. 1. Client system 120 may comprise, among other things, a connector 122, a credentials vault 124, a connection agent 126, and one or more target resources 128. System environment 100 may represent a system or network environment in which client identity 110 requests access to target resource 128 remotely. System environment 100 may be configured to provide client identity 110 access to target resource 128 using native web applications (i.e., without requiring a dedicated application, webpage, etc.) and without requiring separate credentials. Further details regarding this system are provided below.

The various components of system 100 may communicate over a network 140. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across one or more of these forms of networks and protocols. While system environment 100 is shown as a network-based environment, it is understood that in some embodiments, one or more aspects of the disclosed systems and methods may also be used in a localized system, with one or more of the components communicating directly with each other.

Client identity 110 may refer to any identity that may access files associated with target resource 128. In some embodiments, client identity 110 may refer to a particular user or account (e.g., data and/or instructions representing an individual or service account). For example, client identity 110 may include a user 112 associated with one or more credentials for accessing target resource 128. In some embodiments, client identity 110 may include a client device 114 through which user 112 may access target resource 128. For example, client device 114 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may engage in remote access to target resource 128. In some embodiments, client identity 110 may be a virtual machine (e.g., based on AWS™, Azure™, IBM Cloud™, etc.), container instance (e.g., Docker™ container, Java™ container, Windows Server™ container, etc.), or other virtualized instance. In some embodiments, client identity 110 may be a software instance or application executing on client device 114. Using the disclosed methods, client identity 110 may access target resource 128 remotely without the need for specific credentials, a VPN, a dedicated agent, etc. As used herein, a “client” may refer collectively to client identity 110, to user 112, an account associated with user 112, or to client device 114. In some embodiments, client device 114 may employ a local agent, such as security agent 702 for brokering secure connections in a secure and transparent manner, as described further below.

In some embodiments, client identity 110 may be authorized through system environment 100 using a multi-factor authentication process. This may include authenticating client identity 110, at least in part, through verifying an object in the possession of user 112. Accordingly, system environment 100 may further include a device, such as mobile device 116, for authenticating client identity 110. Mobile device 116 may include any computing device associated with user 112 that is separate from client device 114. For example, mobile device 116 may include a mobile phone, a tablet, a wearable device (e.g., a smart watch, smart jewelry, implantable device, fitness tracker, smart clothing, head-mounted display, etc.). In some embodiments, mobile device 116 may be configured to receive push notifications or other electronic communications requesting authentication of client identity 110. Further, mobile device 116 may include a display configured to display graphical user interfaces for selecting accounts and/or target resources, or performing other functions associated with the disclosed techniques.

Client identity 110 and/or mobile device 116 may communicate with client system 120 through network 140. Client identity 110 may be configured to participate in remote native access sessions with client system 120 for accessing target resource 128. As used herein, a remote native access session may refer to any network-based remote connection that is accessed through native software and components of the client device 114. In some embodiments, the remote native access session may be a remote desktop connection. Accordingly, the native software may include a remote desktop client that is not specific to client system 120 or cloud service 130. For example, the remote desktop client may include a client integral to an operating system of client device 114, such as a Microsoft™ remote desktop protocol (RDP) client, or similar RDP clients. Accordingly, the remote native access session may be accessed without the need for a dedicated client (e.g., a VPN client), a webpage browser (e.g., through a web portal, an HTML5 gateway, etc.), or the like.

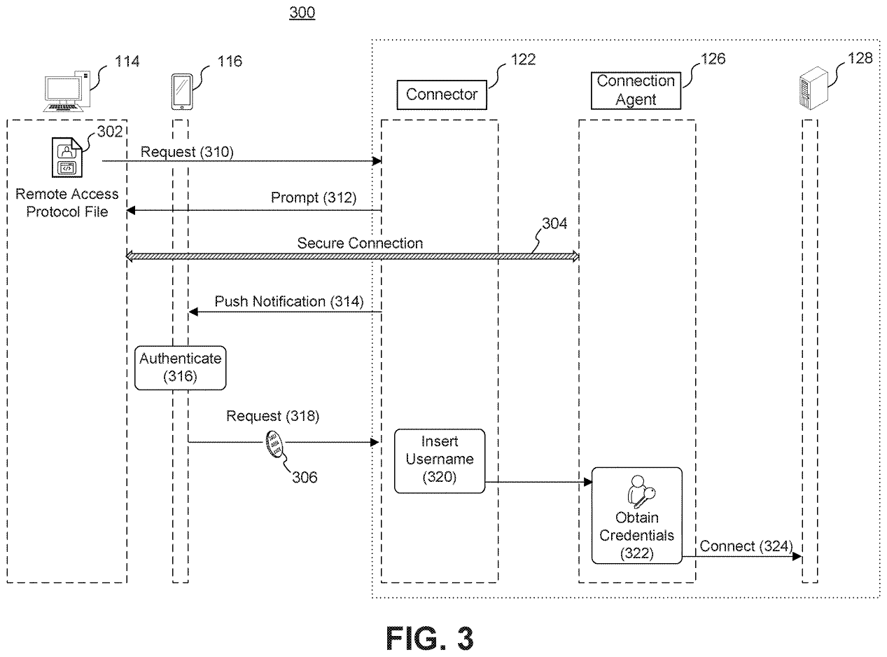

Further, the remote native access session may be dynamic. As used herein, a dynamic connection may be one that is established without initially identifying one or more aspects of the remote access connection. For example, during the connection phase, the account accessing the connection, the target resource (e.g., the target IP address, etc.), the connecting tool (e.g., which application is used), or various other aspects may not be defined. Rather, these or other aspects may be defined after the connection has been established, and potentially after the client identity has been authenticated. In some embodiments, user 112 may specify these aspects over the native connection using client device 114, mobile device 116, or through other methods. Additional details regarding the remote native access session are described below with respect to FIG. 3.

As shown in FIG. 1, client system 120 may include a connector 122. Connector 122 may be a component of client system 120 responsible for receiving requests for remote access sessions. Connector 122 may process these requests and perform additional interfacing steps between client device 114, mobile device 116, cloud service 130, and/or components of client system 120. Connector 122 may be a dedicated server, service, or software component of client system 120, or may be integrated with one or more other components of client system 120.

In some embodiments, client system 120 may further include, or have external access to, a credentials vault 124. Credentials vault 124 may be any form of storage location containing credentials (such as usernames, tokens, passwords, etc.) associated with client system 120 (e.g., CyberArk Enterprise Password Vault™). In particular, credentials vault 124 may store credentials required to access target resource 128. For example, as discussed further below, in situations where client identity 110 has been successfully authenticated, connector 122 and/or connection agent 126 may fetch a secret (e.g., authentication key, credential, token, password, etc.) from credentials vault 124 for authentication of client identity 110 (or a corresponding identity or account) to the appropriate target resource 128. In some embodiments the secrets stored within credentials vault 124 may not be provided to client identity 110. Accordingly, user 112 may be authenticated in a passwordless manner to access target resource 128. In some embodiments, credentials vault 124 may be omitted and the credentials may be stored locally in client system 120, on client device 114 or mobile device 116.

Client system 120 may further include a connection agent 126, as shown in FIG. 1. Connection agent 126 may be a separate component (e.g., a separate software component, a separate server, etc.) or may be integrated with one or more other components of client system 120, such as connector 122. Connection agent 126 may perform tasks associated with establishing a remote access session as described above. Connection agent 126 may further obtain credentials for client identity 110, for example through credentials vault 124. Additional details regarding these and other actions that may be performed by connection agent 126 are provided below with respect to FIG. 3.

In some embodiments, client system 120 may further include a management agent, such as management agent 704 described in further detail below. In some embodiments, management agent 704 may be implemented in place of connector 122 and connection agent 126. Accordingly, management agent 704 may be configured to perform any of the various tasks associated with connector 122 and connection agent 126 described herein. Alternatively, management agent 704 may be separate from connector 122 and connection agent 126, and may perform distinct tasks for establishing access sessions via a local security agent. As yet another alternative, management agent 704 may correspond to one of connector 122 or connection agent 126. In other words, either connector 122 or connection agent 126 may be configured to perform the various tasks described herein with respect to management agent 704. Accordingly, the various embodiments disclosed herein are not restricted to any particular configuration of client system 120.

Client system 120 may further include, or have external access to, a target resource 128. As used herein, a target resource may refer to any resource within a network that may accessed by client system 120 remotely. Examples of network resources may include SQL servers, databases or data structures holding confidential information, restricted-use applications, operating system directory services, access-restricted cloud-computing resources (e.g., an AWS™ or Azure™ server), sensitive IoT equipment (e.g., physical access control devices, video surveillance equipment, etc.), and/or any other computer-based equipment or software that may be accessible over a network.

In some embodiments, target resource 128 may be a privileged resource, such that access may be limited or restricted. For example, access to the requested resource may require a privileged credential (e.g., a password, a username, an SSH key, an asymmetric key, a security or access token, etc.), membership in a privileged access group (e.g., Microsoft Active Directory™ group, AWS Identity and Access Management™ group, etc.), or other form of privileged access rights. In some embodiments, credentials vault 124 may store privileged credentials required for accessing target resource 128, as described above.

In some embodiments, system environment 100 may include a cloud service 130, as shown in FIG. 1. Cloud service 130 may be a cloud-based service configured to perform tasks associated with facilitating the connection between client device 114 (and/or mobile device 116) and client system 120. For example, cloud service 130 may be configured to receive or intercept access requests from client device 114 and may route them to connector 122. Additional details regarding these and other actions that may be performed by service 130 are described below with respect to FIG. 3.

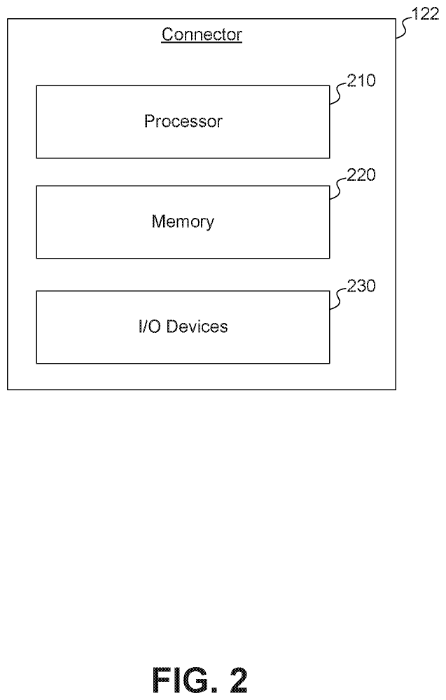

FIG. 2 is a block diagram showing an example connector 122, consistent with the disclosed embodiments. As described above, connector 122 may be a computing device (e.g., a server, etc.) and may include one or more dedicated processors and/or memories. For example, connector 122 may include a processor (or multiple processors) 210, a memory (or multiple memories) 220, and/or one or more input/output (I/O) devices 230, as shown in FIG. 2. In some embodiments, connector 122 may be integrated with one or more other components of client system 120. For example, processor 210 and/or memory 220 may also be associated with credentials vault 124, connection agent 126, target resource 128, and/or security agent 702, depending on the implementation. Accordingly, any description of components or functions of connector 122 herein may equally apply to security agent 702.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. The processor 210 may also be based on the ARM architecture, a mobile processor, or a graphics processing unit, etc. The disclosed embodiments are not limited to any type of processor configured in client system 120.

Memory 220 may include one or more storage devices configured to store instructions used by the processor 210 to perform functions related to client system 120. The disclosed embodiments are not limited to particular software programs or devices configured to perform dedicated tasks. For example, the memory 220 may store a single program, such as a user-level application, that performs the functions associated with the disclosed embodiments, or may comprise multiple software programs. Additionally, the processor 210 may, in some embodiments, execute one or more programs (or portions thereof) remotely located from connector 122. Furthermore, memory 220 may include one or more storage devices configured to store data for use by the programs. Memory 220 may include, but is not limited to a hard drive, a solid state drive, a CD-ROM drive, a peripheral storage device (e.g., an external hard drive, a USB drive, etc.), a database, a network drive, a cloud storage device, or any other storage device.

I/O devices 230 may include one or more network adaptors or communication devices and/or interfaces (e.g., WIFI, BLUETOOTH, RFID, NFC, RF, infrared, Ethernet, etc.) to communicate with other machines and devices, such as with other components of system environment 100 through network 140. For example, client system 120 may use a network adaptor to receive and transmit communications pertaining to access requests within system environment 100. In some embodiments, I/O devices 230 may also include interface devices for interfacing with a user of client system 120. For example, I/O devices 230 may comprise a display, touchscreen, keyboard, mouse, trackball, touch pad, stylus, printer, or the like, configured to allow a user to interact with client system 120.

FIG. 3 is a block diagram illustrating an example process 300 for providing native remote access to target resources, consistent with the disclosed embodiments. Process 300 may allow a client, such as client identity 110, to establish a secure connection 304 with client system 120 for accessing target resource 128. As used herein, accessing the target resource 128 may include any operations by a client device involving data or information stored on target resource 128. For example, this may include reading information stored on target resource 128, storing information on target resource 128, deleting or modifying information on target resource 128, or any other forms of operations requiring access to the target resource. In some embodiments, access may be restricted to privileged client identities, as discussed above.

As part of process 300, client device 114 may transmit a request in step 310 for accessing target resource 128 of client system 120. In some embodiments, client device 114 may access a remote access protocol file 302. This remote access protocol file 302 may include information for establishing secure connection 304. In particular, remote access protocol file 302 may include information identifying client identity 110 (e.g., an account associated with user 112, etc.) and information identifying a target host for the connection (e.g., connector 122, credentials vault 124, and/or connection agent 126). For example, this information may be represented as an address for a target host, which may include a server name indication (SNI) as part of a transport layer security (TLS) protocol, or any other suitable form of address. In some embodiments, remote access protocol file 302 may be a proprietary protocol file, such as a remote desktop protocol (RDP) file associated with Windows Remote Desktop™, or the like. Of course, remote access protocol file 302 may correspond to other protocols as well. Accordingly, client device 114 may send the request in step 310 using native remote access software, without the need for a VPN client, a browser-based interface, or other non-native software.

In the example of an SNI address, the remote access protocol file 302 may be presented in the form userID.address, where userID is a prefix added to the target host address. In some embodiments, the user ID may be a personal telephone number (e.g., mobile number), or other identifier associated with user 112. In some embodiments, process 300 may include a step of modifying the address within remote access protocol file 302 to include the user ID. For example, user 112 may manually modify the address to include a phone number or other identifier associated with user 112 through a text-based file editor, a graphical user interface, a mobile application, or any other suitable interface. In other embodiments, the user ID may be automatically added, for example, by client device 114, by cloud service 130, or other components of system environment 100. While the userID.address format is provided by way of example, any other suitable formats may be used for representing the user information and the address within remote access protocol file 302. For example, the user ID may be included in a designated field, appended as a suffix to the address, or otherwise included in the file.

Notably, in some embodiments, remote access protocol file 302 and the request of step 310 may not include credentials required to access target resource 128 and may not specifically identify target resource 128. In such embodiments, secure connection 304 may be dynamic in that the connection may be established initially and the details regarding the specific target resource and the user's credentials may be determined subsequently, as described further below. For example, remote access protocol file 302 may include fields or designated spaces for a username and password or other credentials of client identity 110. These fields or spaces may be empty, may include a default text (e.g., “BLANK”), or may include an identifier for identifying the credential fields in later stages. Omitting the user's credentials in this way may improve security by eliminating a potential for the user's credentials to be stolen or otherwise obtained by an attacker. Further, process 300 would not require user 112 to enter separate credentials for accessing client system 120. Thus process 300 allows for a passwordless remote connection to target resource 128. Additional details regarding the authentication of client identity 110 are provided below.

Remote access protocol file 302 may be accessed by client identity 110 in various ways. For example, remote access protocol file 302 may be stored in a memory of client device 114, such as on a local hard drive, a solid state drive, a removable drive, or the like. In some embodiments, remote access protocol file 302 may be stored externally. For example, remote access protocol file 302 may be stored on a cloud-based platform (e.g., in cloud service 130, or other cloud locations), on a remote server, on a separate computing device, or the like. In some embodiments, cloud service 130 may generate remote access protocol file 302 and provide it to client identity 110 for accessing client system 120 and/or other systems.

In some embodiments, the request in step 310 may not be transmitted directly to connector 122. For example, user device 114 may transmit the request to cloud service 130, which may route the request to the correct target host based on the address included in remote access protocol file 302. This may include, for example, extracting the SNI address described above and mapping it to the appropriate connector. Accordingly, cloud service 130 may include or may have access to a database of connector network addresses, connector identifiers, and/or other information to facilitate routing requests in step 310.

In step 312, connector 122 may send a prompt to client device 114 to establish a secure connection 304 with connection agent 126. For example, secure connection 304 may be a tunnel connection, such as a connection using the TLS protocol, or a similar connection protocol. While TLS is used by way of example, it is to be understood that various other forms of secure connections may be used, and the present disclosure is not limited to any particular connection protocol or configuration. Further, while secure connection 304 is shown between client device 116 and connection agent 116, the connection may be with any component or subcomponent of client system 120, including connector 122.

Once the connection has been successfully tunneled, connector 122 may generate and send a push notification in step 314. The push notification may be received through a mobile application on mobile device 116. Through the push notification, user 112 may be prompted for authentication and target account selection. Authentication step 316 may occur in a variety of ways. In some embodiments, authentication may occur by virtue of user 112 having mobile device 116 in his or her possession. Accordingly, the push notification transmitted in step 314, along with the identification of the user in the request in step 310, may provide multi-factor authentication for client identity 110. In some embodiments, additional authentication may be performed, such as biometric authentication (e.g., a retinal scan, facial recognition, a fingerprint scan, a voiceprint identification, etc.), a user pin, a password, scanning a QR code, or the like. According to some embodiments of the present disclosure, an authentication protocol, such as OpenID or Security Assertion Markup Language (SAML), may be used in step 316.

Through mobile device 116, user 112 may also select an account for accessing target resource 128. In some embodiments, the account may be selected automatically. For example, user 112 may be associated with only one account, or may have a preferred or default account that is selected. In other embodiments, user 112 may select from a plurality of accounts through a user interface.

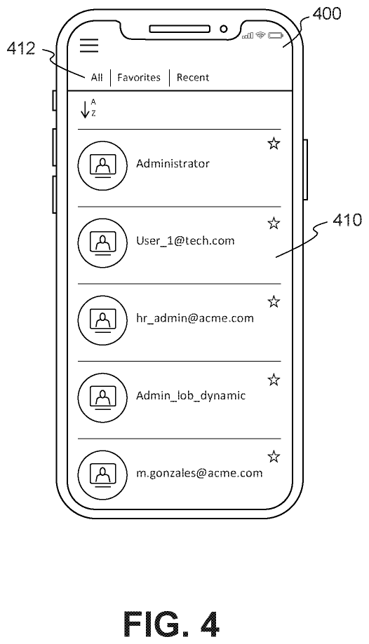

FIG. 4 illustrates an example user interface 400 for selecting an account, consistent with the disclosed embodiments. User interface 400 may be displayed, for example, on mobile device 116 and may be associated with a mobile application. As shown in FIG. 4, user interface 400 may present a plurality of accounts, such as account 410, that the user may select through the display of mobile device 116. User interface 400 may further include filters or other options for configuring the display of the available accounts. For example, user interface 400 may include filters 412 for filtering or sorting by accounts designated as favorites, recent accounts selected by user 112, or various other attributes. User interface 400 is shown by way of example, and various other configurations or formats may be used. In some embodiments, the user interface 400 may be presented through a separate device, such as client device 114, or another device accessible by user 114 (e.g., a laptop computer, a tablet, a smartwatch, etc.).

Returning to FIG. 3, process 300 may include a step 318 for transmitting a request to connector 112 for accessing target resource 128. This request may include a token 306, that is provided to connector 122. In some embodiments, token 306 may be a temporary token generated by mobile device 116 for one-time access to client system 120. In some embodiments, token 306 may be generated by another device or service, such as cloud service 130. In some aspects of the present disclosure, token 306 may further be valid only for a limited period of time.

Token 306 may include an identifier of target resource 128. For example, client system 120 may include a plurality of target resources associated with target identity information, and token 306 may identify target resource 128 from among the plurality of target resources. The target identity information may be stored locally within client system 120 (e.g., in memory 220) or in an external storage location (e.g., a remote server, a cloud-based platform, etc.).

In step 320, connector 122 may then modify the request to include a username based on token 306. In some embodiments, this may include intervening in the remote desktop protocol to replace the remote desktop username in the request of step 310 with token 306. For example, as described above, remote access protocol file 302 may include a username field that is blank, or that has a placeholder or default value. Accordingly, step 320 may include inserting the blank username or replacing the placeholder with token 306, which will serve as the username for accessing target resource 128. Therefore, the connection may be established initially without requiring the username to be included in the request of step 310.

In step 322, connection agent 126 may receive credentials associated with token 306. In some embodiments, the credentials may be received from credentials vault 124. For example, connection agent 126 may receive token 306 and may use token 306 to retrieve credentials corresponding to account 410 selected by user 112. Connection agent 126 may then assert the retrieved credentials at target resource 128 on behalf of client identity 110, as shown in step 324. Accordingly, client identity 110 may access target resource 128 without receiving the credentials from credentials vault 130, which may reduce security vulnerabilities in system environment 110 by preventing them from being exposed to attackers. Further, a separate password is not required for accessing target resource 128 through the remote access protocol used by client device 114. Access can also be granted without the need for a dedicated client, such as a VPN client, a browser-based interface, or other non-native system components.

In some embodiments, steps 322 and 324 may be performed without connection agent 126. For example, connector 122 may access the credentials of step 322 directly from credentials vault 124, without connection agent 126, and may further assert the credentials on behalf of client identity 110. In some embodiments, the credentials may not be retrieved by connector 122 or connection agent 126, but may be provided by client device 114. For example, the credentials may be stored locally (e.g., in a cache, etc.) on client device 114. In some embodiments, client identity 110 may receive the credentials after they are obtained in step 322. For example, after step 322, connection agent 126 and/or connector 122 may transmit the obtained credentials to client device 114 and/or mobile device 116.

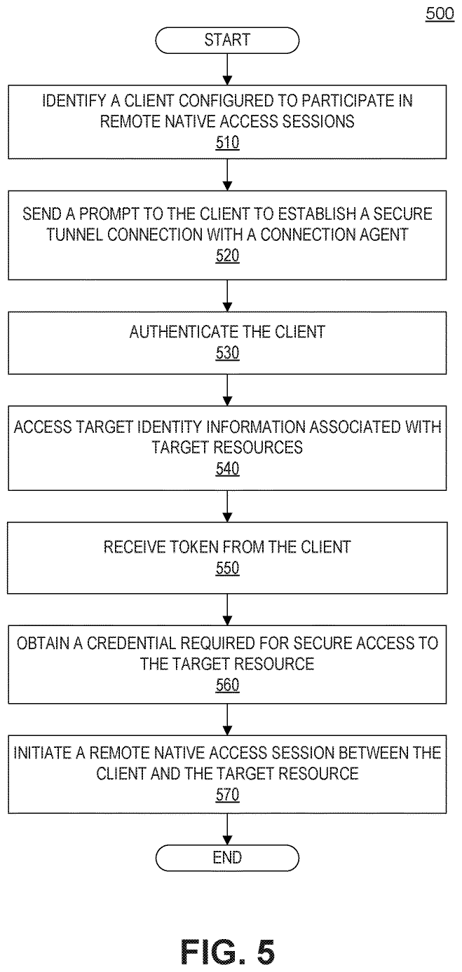

FIG. 5 is a flowchart depicting an example process 500 for securely establishing secretless and remote native access sessions, consistent with the disclosed embodiments. Process 500 may be performed by at least one processing device, such as processor 210 of connector 122, as described above. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 500. Further, process 500 is not necessarily limited to the steps shown in FIG. 5, and any steps or processes of the various embodiments described throughout the present disclosure may also be included in process 500, including those described above with respect to FIG. 3.

In step 510, process 500 may include identifying a client configured to participate in remote native access sessions. For example, step 510 may identify client identity 110 and thus the client may include user 112, an account associated with user 112, and/or client device 114. The client may be identified in various ways. In some embodiments, the client may be identified based on a request received from client device 114, as shown in step 310 of FIG. 3. In some embodiments, the client may have a remote access protocol file that has been modified to include an identifier associated with the client. For example, the client may access remote access protocol file 302, as discussed above, which may have been modified to include at least one of a mobile telephone number, an email address, a user name, an account name, a custom identifier created by the client, a random or semi-random identifier, a customer number, an IP address, or various other identifiers that may be associated with the client. The remote access protocol file 302 may be modified by the client or may be modified by other components of system environment 100, including cloud service 130. In some embodiments, the client may be identified by cloud service 130 as described above. For example, cloud service 130 may extract an address (e.g., an SNI indicating a hostname) from a request from client identity 110 and may route the request based on the address. In some embodiments, the remote access protocol file 302 may comply with a remote desktop protocol, as described above.

In step 520, process 500 may include sending a prompt to the client to establish a secure tunnel connection with a connection agent using the identifier associated with the client. For example, step 520 may correspond to step 312 for establishing secure connection 304 with connection agent 126, as described above with respect to FIG. 3. The secure tunnel connection may include any form of secure connection according to a tunneling protocol, including, but not limited to TLS, IP in IPv4/IPv6, Generic Routing Encapsulation (GRE), Secure Socket Tunneling Protocol (STTP), Internet Protocol Security (IPSec), Layer 2 Tunneling Protocol (L2TP), Virtual Extensible Local Area Network (VXLAN), or the like. As shown in FIG. 1, connection agent 126 and target resource 128 may be included in the same client system 120. Accordingly, the connection agent may be located in a local network, a virtual network, or other form of network in which the target resource 128 is also located.

In step 530, process 500 may include authenticating the client, which may be performed in various ways. For example, authentication of the client may be performed according to at least one of OpenID, SAML, or similar authentication protocols. In some embodiments, step 530 may include sending a push notification to a mobile device associated with the client. For example, mobile device 116 may receive a push notification as shown in step 314 and described above. Accordingly, the mobile device 116 may be configured to authenticate the client through an application on mobile device 116.

In step 540, process 500 may include accessing target identity information associated with one or more target resources. For example, client system 120 may include a plurality of target resources, including target resource 128, each which may be associated with target identity information. This target identity information may be stored, for example, in a database, a memory device (e.g., memory device 220), on a remote server or cloud-storage platform, or various other storage locations. In some embodiments, the plurality of target resources may be identified based on the identified client. For example, the plurality of target resources are identified based on access rights of the client, or based on the authentication of the client.

In step 550, process 500 may include receiving from the client a token that identifies a target resource from among the one or more target resources. For example, step 550 may include receiving token 306, as described above with respect to FIG. 3. In some embodiments, the target resource 128 may be selected by a user. Accordingly, process 500 may further include receiving a selection by the client of the target resource 128 from among the plurality of target resources. In some embodiments, the selection may be made through a graphical user interface, similar to user interface 400 shown in FIG. 4. For example, process 500 may further comprise sending to the client data for generating a selectable menu of the plurality of target resources. The selectable menu of the plurality of target resources comprises icons and identifying data associated with the plurality of target resources.

In step 560, process 500 may include obtaining, based on the token, a credential required for secure access to the target resource. For example, step 560 may comprise obtaining credentials associated with the target resource 128 identified in the token. As described above with respect to FIG. 3, the credential may be obtained from a secure credentials vault, such as credentials vault 124. Accordingly, the credential may be obtained without making the credential available to the client. In other embodiments, the credential may be obtained locally at the client, and deleted at the client upon termination of the remote native access session. As described above with respect to step 322, in some embodiments, the credential may be obtained in a secretless manner from the perspective of the client. Accordingly, the client may not be required to submit the credential or other credentials for accessing the target resource 128. In some embodiments, process 500 may further include replacing a username in a request for the remote native access session with data from the token. For example, process 500 may include inserting the token or data from the token into the remote access protocol file associated with the client. Alternatively, this may be performed by connection agent 126, or other components of client system 120.

At step 570, process 500 may include initiating, using the credential, a remote native access session between the client and the target resource. Accordingly, process 500 may allow the client to access the target resource in a passwordless manner (and without requiring transmission of other forms of secure credentials) and may be done through native remote protocol software (e.g., without requiring a separate agent or non-native software). As discussed above, the remote native access session may comply with various different remote access protocols and techniques.

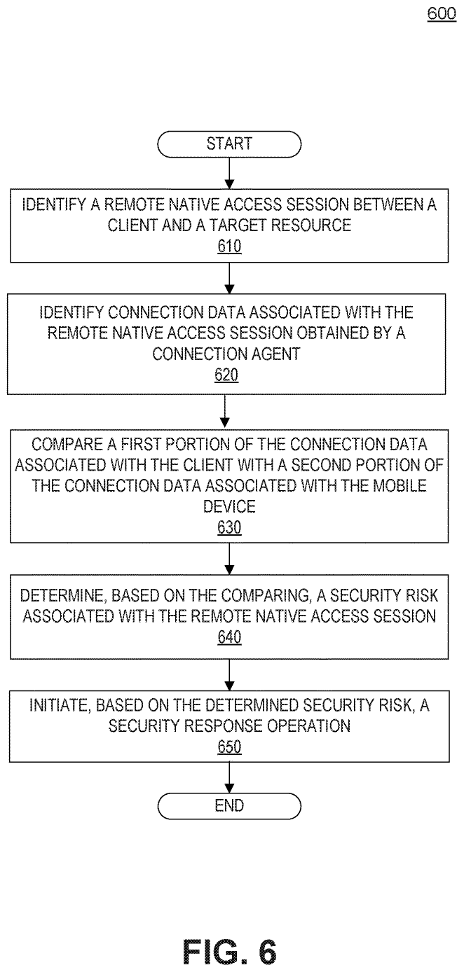

Consistent with above embodiments, additional disclosed embodiments relate to detecting and addressing security risks in remote native access sessions. Such embodiments are discussed in connection with FIG. 6 and process 600, as detailed further below.

In some embodiments, a security system (e.g., cloud service 130 or connector 122) may be an entity conducting a security assessment and may detect and address security risks in remote native access sessions. The system may collect or receive connection data from a user device (e.g., devices 110, 112, or 114), from connector 122, or from target resource 128. The data may include, for example, an RDP version, desktop information (e.g., width or physical width, height or physical height, color depth, high color depth, supported color depths, orientation, desktop scale factor, device scale factor, etc.), keyboard information (e.g., layout, type, subtype, function key, file name, etc.), client information (e.g., client hostname, software information, build, product ID, serial number, etc.), security data (e.g., encryption methods being used or configured, etc.), network data (e.g., RDP channels requested by the client, etc.), monitor data (e.g., resolution, orientation, etc.), client information (e.g., address family, client address, MAC address, RDP client directory, session ID, flag settings, etc.), time zone information (e.g., time zone, time zone key name, daylight savings data, etc.), sensor data (e.g., from a pedometer, GPS, gyroscope, etc.), and various other types of data. Based on this data, unique profiles may be developed for individual clients or identities, reflecting how they typically or frequently engage in remote access sessions and using what devices. In some embodiments, if the system detects an anomaly or a security threat, the system may prompt the user or an administrator with a security notification (e.g., “change your password” or “your session may be dangerous” or the like). Alternatively or additionally, the system may provide a security notification describing the threat incident to an administer or prompt a security center with a notification about the incident (e.g., “a threat is detected, “malicious connection is being made,” or “your organization is under attack” or the like).

Other risks identified by the system may take a variety of forms. For example, if a user connecting from an endpoint machine (e.g., endpoint 110 or 114) is in one time zone, but their mobile device (e.g., mobile device 116) is in another time zone, that may be determined to deviate from a typical or standard behavioral pattern for the user. Similarly, if the IP geolocation of the endpoint device does not match the IP geolocation of the mobile device, that may also be deemed anomalous. Likewise, if the endpoint and mobile device have different keyboard layouts (e.g., one in English and the other in Chinese), that may be determined to be anomalous. Additional examples of potentially anomalous activity that may be detected based on the collection session data include, as examples: the system expects both devices to be on a corporate network (WIFI or LAN) and have the same IP, but one has a different network address; the system detects in the RDP protocol mouse-clicks or keyboard presses from the endpoint, but also gets sensor input from the mobile device (e.g., pedometer or steps counter) indicating the user is walking (violating an assumption or determined pattern that a user usually should not be typing and walking at the same time); a user usually connects from an endpoint machine that has a certain amount of screens and screen resolution (this is data that is available in RDP), but then connects from an endpoint with a different screen configuration (considered to be more risky and may trigger an action), and various others.

In some embodiments, such detected anomalous activity may be assigned a weighted or unweighted risk score that may be added to a weight-based algorithm. For example, weights may be applied to certain types of data (e.g., IP address of client) that are determined to be more probative of anomalous activity than others (e.g., time of day). The combined risk score may affect the security mitigation and actions that may be applied on the session, as discussed further below. These techniques may advantageously be applied to various industries, including cyber security and financial fraud alerts, among others.

Further, in some embodiments, instead of mere access control, the system may scan a network to identify anomalies (e.g., look for suspicious actors even if the actors are not seeking access to a target). For example, on a continuous or periodic basis, the system may collect and analyze connection data for connected identities. This may be performed both for building behavioral profiles used in detecting anomalous activity, and in detecting anomalous activity itself.

In some embodiments, the system may detect anomalies by analyzing device activities, device location, and device settings. For example, the system may detect an anomaly when a user device or mobile device is determined to be doing something it does not typically do, when a user device is making a connection it does not typically make, when a user is walking faster than usual (e.g., tracked via the user device's pedometer or GPS), when a user and their device are in different locations, when a user or their user device are doing things that they're not supposed to do or they have not done in the past, when a user and their device have different networks or zones, when configuration settings are different than what the IT administrator pushed out, or when hardware configurations (e.g., monitor, other peripheral devices, keyboard, etc.) are different than expected (e.g., if the user device has a keyboard in English and an endpoint is connecting from a keyboard using a different language), etc. For example, the system may analyze a correlation between a user's mobile device and the specific data the system may have in some network protocols in order to make the determination of the anomaly.

Device activities may also be analyzed using sensor data from the hardware of the device (e.g., device 114 or 116). For example, if the system detects from a pedometer of a mobile device that the user is walking very fast or running, it would not make sense for the user to be performing a connection at that point. An activity like running while trying to perform a connection may raise an alert. Sitting on a train, though, may not raise an alert (measuring actual steps rather than velocity/acceleration).

Possible security mitigations or actions that may be invoked after a certain risk is identified or reached may take various forms. Examples include: closing or suspending the user's RDP session; limiting the number of RDP sessions that the user can open; triggering an alert to an administrator or security server; requiring an administrator or security server to approve the secretless connection before it starts; limiting the user's actions during the session to non-privileged actions; starting a video recording or keystroke logging of the session, or starting to record the RDP traffic for audit; disabling RDP capabilities such as clipboard, driving mapping or printer's redirection (so the user may not copy files or data from the target machine 128); and requiring an additional factor for the session to start (e.g., sending a one-time password to the user's phone or email). Various other security responses are possible as well.

In some embodiments, the system may be implemented in multiple locations. For example, the system may be implemented locally at the target 128; at the client or user itself (e.g., client device 114 of 116); or in the middle and acting as the connector 122.

Aspects of this disclosure may include identifying a remote native access session between a client and a target resource. As discussed above, a remote native access session may refer to any network-based remote connection that is accessed through native software and components of the client device 114 or 116 of FIG. 1. In some embodiments, the remote native access session may be a remote desktop (e.g., RDP or other) connection. Accordingly, the native software may include a remote desktop client (e.g., RDP or other client) that is not specific to client system 120 or cloud service 130 of FIG. 1. Further, the remote native access session may be dynamic. As used herein, a dynamic connection may be one that is established without initially identifying one or more aspects of the remote access connection. In some embodiments, the system may identify a remote native access session between client device 114 or 116 and target resource 128 via network 140 of FIG. 1, consistent with above embodiments.

Aspects of this disclosure may include identifying connection data associated with the remote native access session obtained by a connection agent (e.g., agent 126), wherein the connection data originates from the client (e.g., client 114) and/or from a mobile device (e.g., mobile device 116) associated with a user 112, and comprises data indicative of at least one of: hardware of the client or mobile device, configuration settings of the client or mobile device, and network connection attributes of the client or mobile device.

Identifying connection data associated with the remote native access session obtained by the connection agent 126 may occur in different places, as described above. The connection agent 126 may be at the client 114 or 116, in some embodiments, or separate as shown in FIG. 1. The connection agent 126 may also be at the target resource 128. Alternatively, the connection agent 126 may be at an intermediary location (e.g., proxy server or gateway) doing a proxying or intercepting function. Accordingly, the system may identify the connection data associated with the remote native access session through various techniques. Connection data may be data exchanged during the session and may include hardware data, hardware parameters, and various other types, as discussed above.

In some embodiments, the system identifies connection data obtained by a connection agent 126 somewhere, where the connection data originates from the client 114 and/or from a mobile device 116 associated with the user 112. Accordingly, the connection data may be derived from one or more different places and may be compared to each other. In some embodiments, the connection data is data indicative of at least one of: hardware of the client or mobile device, configuration settings of the client or mobile device, and network connection attributes of the client or mobile device. Thus, the connection data may include data from the client and the mobile device, but the data can be of these three different categories (hardware, configuration, and network) from the client or the mobile device. In other words, the system does not have to do a comparison on every type of data; the comparison may simply be one side that is available (e.g., compare the data from the mobile device and the client device).

In some embodiments, the system is not merely gathering data, but is further identifying data (e.g., connection data) from a remote native access (any data that may be available in this type of environment). This may occur by, for example, activity scanning a network environment for connections and connection data.

In some embodiments, there is a great deal of collectable and identifiable information that is passed from the endpoint machine through the RDP protocol (e.g., endpoint IP, time zone, keyboard layout, screen resolution, etc.), which may help profile a user 112's activity and assist in detecting malicious connections and anomalies. Further, there is information that may be collected and identified at the user's mobile device 116 during a session and that cross-referenced with endpoint machine information. Such information may include the mobile device's IP address, time zone, keyboard layout, etc. Based on this data and the correlation between the data collected from both user devices (e.g., mobile device and endpoint machine), the system may develop a risk engine that may invoke security mitigation mechanisms if some risk level is reached.

For example, with reference to FIG. 1, at cloud service 130, the system may receive data sent from the mobile device 116 to the cloud service 130. At connector 122, the system may intercept RDP messages sent from the endpoint machine 114.

In some embodiments, the following data may be collected from an endpoint using the RDP protocol:

| Message | Data type |
|---|---|
| Connect | clientCoreData-Core Data: |
| Initial | RDP Version |
| PDU | Desktop information: |
| | desktopWidth |
| | desktopHeight |
| | colorDepth |
| | postBeta2ColorDepth |
| | highColorDepth |
| | supportedColorDepths |
| | desktopPhysicalWidth |
| | desktopPhysicalHeight |
| | desktopOrientation |
| | desktopScaleFactor |
| | deviceScaleFactor |
| | Keyboard information |
| | keyboardLayout |
| | keyboardType |
| | keyboardSubType |
| | keyboardFunctionKey |
| | imeFileName |
| | Client info: |
| | clientName (client hostname) |
| | client software information |
| | clientBuild |
| | clientProductId |
| | serialNumber |
| | clientDigProductId |
| | clientSecurityData - Security Data: |
| | Encryption methods - security-related information |
| | used to advertise client cryptographic support |
| | clientNetworkData - Network Data: |
| | RDP channels requested by the client (channels |
| | for: clipboard, drives, etc.) |
| | clientMonitorData\clientMonitorExtendedData |
| | Number of client machine monitors |
| | Resolution of monitors and\or orientation |
| Client | TS_INFO_PACKET\ |
| Info | TS_EXTENDED_INFO_PACKET |
| PDU | Client network information: |
| | clientAddressFamily |
| | cbClientAddress |
| | clientAddress |
| | Client OS information |
| | clientDir (RDP client directory) |
| | clientSessionId-the OS session id the user is |
| | connecting from |
| | performanceFlags |
| | Time zone information: |
| | clientTimeZone |
| | dynamicDSTTimeZoneKeyName |
| | dynamicDSTTimeZoneKeyName |
| | dynamicDaylightTimeDisabled |

Further, TLS Client Hello messages may be saved as they contain data that can fingerprint the SSL library that the client may use for encrypting the session. Additionally, the following data may be collected and identified from a user mobile device 116: time zone, keyboard layout, IP address (which may be used for detecting the device geolocation), and sensor information (e.g., pedometer, GPS, gyroscope, etc.).

In some embodiments, the connection agent 126 is configured to intercept the connection data. Further, in some embodiments, the connection agent 126 is configured to transmit the connection data to a security service (e.g., cloud service 130) that performs the comparing. Additionally, in some embodiments, the connection data includes handshake data associated with the remote native access session. In such embodiments, handshake data may include negotiation of encryption methods (SSL negotiation).

Aspects of this disclosure may include comparing a first portion of the connection data associated with the client with a second portion of the connection data associated with the mobile device 116. In some embodiments, the system may compare a first portion of the connection data associated with the client with a second portion associated with the mobile device. At least some of what the system has previously collected from the user mobile device 116 and at least some of what the system has previously collected from the client device 114 may be compared. Then, based on the comparisons, the system may determine comparative security risk associated with the remote native access session.

In some embodiments, the system has a universe of data that it may identify and analyze (e.g., connection data). Comparing of the connection data does not need to be based on all of the connection data in every situation. The comparison instead may be based on only a portion (e.g., a first portion of the connection data associated with the client and a second portion associated with the mobile device).

Aspects of this disclosure may also include determining, based on the comparing, a security risk associated with the remote native access session. By way of one example, the system may compare a first portion of data associated with the client 114 and a second portion of data associated with a mobile device 116 and finally determine a security risk based on the comparison.

Aspects of this disclosure may further include initiating, based on the determined security risk, a security response operation. By way of one example, after determining a security risk (and it's level), the system may provide a security response operation such as a security notification (e.g., “change your password” or “your session may be dangerous,” etc.) or a security notification describing the threat incident to an administer or prompt a security center with a notification about the incident (e.g., “a threat is detected, “malicious connection is being made,” or “your organization is under attack,” etc.).

In some embodiments, initiating the security response operation includes sending an identification of the security risk to a network security platform (e.g., cloud service 130). By way of one example, the system may forward a notification identifying the security risk to a network security platform.

In some embodiments, initiating the security response operation includes performing the security response operation in the remote native access session. By way of one example, the system may perform a security response operation in the remote native access session such as recording the user session in response to a risk being identified.

In some embodiments, the security response operation includes at least one of: suspending or terminating the remote native access session. By way of one example, the system may end the user's session in response to a risk being identified.

In some embodiments, the security response operation includes at least one of: limiting network rights of the client or limiting local rights of the client. By way of one example, the system may only allow the user to access certain areas and block off other areas in response to a risk being identified.

In some embodiments, the security response operation includes at least one of: generating an alert, making an audit record, or generating a report. By way of one example, the system may provide an alert message such as “your session has been compromised,” etc., in response to a risk being identified.

In some embodiments, the security response operation includes at least one of: requesting authorization from an administrator or requesting authentication from the client. By way of one example, the system may ask a network administrator or security system (e.g., cloud service 130) to authenticate a user 112 in response a risk being identified.

FIG. 6 is a flowchart depicting an example process 600 for detection of security risks based on secretless connection data, consistent with the disclosed embodiments. Process 600 may be performed by at least one processing device (e.g., cloud service 130, connector 122, etc.), such as processor 210 of connector 122, as described above. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 600. Further, process 600 is not necessarily limited to the steps shown in FIG. 6, and any steps or processes of the various embodiments described throughout the present disclosure may also be included in process 600, including those described above with respect to FIGS. 3 and 5.

In step 610, process 600 may include identifying a remote native access session between a client 114 and a target resource 128. For example, step 610 may identify a remote native access session between client device 114 and target resource 128. The remote native access session may be identified in various ways. In some embodiments, the remote native access session may be a remote desktop (e.g., RDP or other) connection.

In step 620, process 600 may include identifying connection data associated with the remote native access session obtained by a connection agent 126, wherein the connection data originates from the client 114 and from a mobile device 116 associated with a user 112, and comprises data indicative of at least one of: hardware of the client or mobile device, configuration settings of the client or mobile device, and network connection attributes of the client or mobile device. For example, at step 620, the connection data may be derived from one or more different places including hardware of the client 114, configuration settings, or network connection attributes.

In step 630, process 600 may include comparing a first portion of the connection data associated with the client 114 with a second portion of the connection data associated with the mobile device 116. For example, at step 630, portions of the connection data derived from one or more different places may be compared to each other. In some embodiments, the comparison may be based on only a portion (a first portion of the connection data associated with the client and a second portion associated with the mobile device).

In step 640, process 600 may include determining, based on the comparing, a security risk associated with the remote native access session. For example, at step 640, the system may determine a security risk or level of risk based on the comparison performed in step 630.

In step 650, process 600 may include initiating, based on the determined security risk, a security response operation. For example, step 650 may include the system providing a security response operation such as a security notification (e.g., “change your password” or “your session may be dangerous,” etc.) or a security notification describing the threat incident to an administer or prompt a security center with a notification about the incident (e.g., “a threat is detected, “malicious connection is being made,” or “your organization is under attack,” etc.). As discussed above, however, various types of security responses are possible.

As described generally above, the disclosed techniques may enable establishing secretless and remote native access sessions via specialized gateway connections, such as through secure connection 304. Thus, as described above, a secure access connection may be established between client device 114 and target resource 128 through native software components of client device 114, such as a Microsoft™ remote desktop protocol (RDP) client, or similar RDP clients. Consistent with some disclosed embodiments, a local security agent may further be implemented at a client device for brokering these sessions. This security agent may enable secure, transparent access obtaining approved runtime access artifacts from client system 120, and routing traffic through this secure system without changing the user's normal workflow.

Accordingly, consistent with the disclosed embodiments, client device 114 may include a security agent 702, as described in further detail below. Security agent 702 may be responsible for brokering the native access sessions between client device 114 and target resource 128. Security agent 702 may be configured to enable users (e.g., identity 112) to use familiar tools such as Microsoft™ Terminal Services Connection (mstsc), OpenSSH™, PUTTY™, or similar tools, where aspects such as authorization, access shaping, and cloud routing are handled by client system 120. Security agent 702 may thus operate transparently to users such that these security operations associated with client system 120 are performed on the backend, with no or minimal visibility to the user. Security agent 702 thus provides a seamless integration between native software tools and the enhanced security features of client system 120.

Security agent 702 may be configured to broker a wide variety of different connection types, each of which may be associated with different native applications or protocols. For example, security agent 702 may be configured to handle multiple different types of connections, each of which may require different brokerage techniques. As one example, security agent 702 may be configured to facilitate remote desktop connections using a Remote Desktop Protocol (RDP). For these connections, security agent 702 may transparently intercept a local remote desktop (RD) gateway access flow to identify a target and user context associated with a request. Security agent 702 may then retrieve approved session parameters from client system 120 and rewrite the session in flight. Security agent 702 may then relay the connection through the client system 120 RD gateway to target resource 128, which may be a target Windows™ or other server.

As another example, security agent 702 may be configured to facilitate Secure Shell (SSH) connections. In this case, security agent 702 may behave like a local SSH agent. Security agent 702 may retrieve approved short-lived SSH access material from client system 120 on demand, which it may keep it in memory for short-lived use. Security agent 702 may then enable the SSH connection through a client system 120 SSH Proxy to the final SSH target. While various example connections and protocols are provided by way of example, security agent 702 is not limited to any particular form of connection and may be applicable in a wide variety of native connection types using similar techniques.

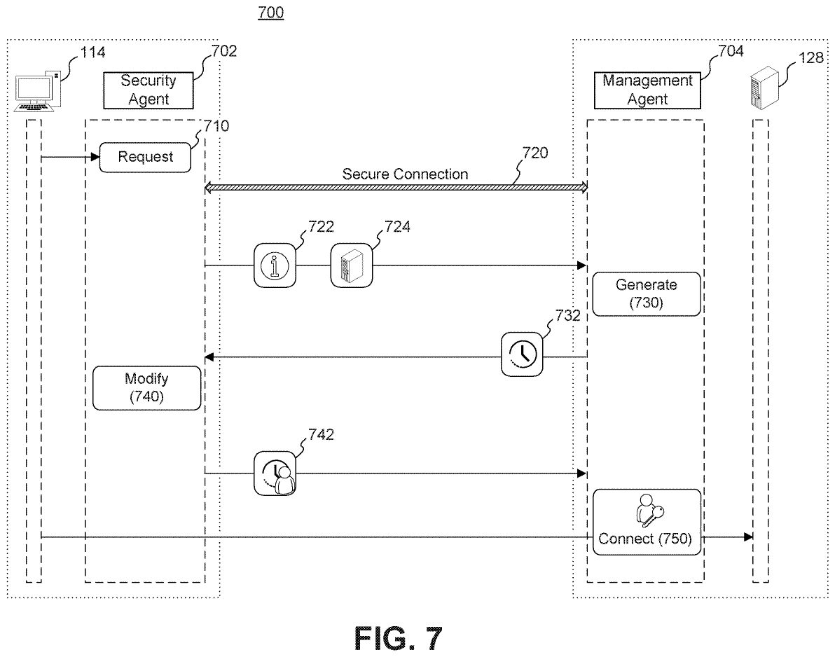

As noted above, security agent 702 may be configured to broker the early part of a standard desktop access flow before the session reaches the client system 120 gateway. For example, security agent 702 may be configured to identify the requested destination, identify the requested user context, retrieve approved session parameters from client system 120, and update the session before it continues upstream. FIG. 7 is a block diagram illustrating an example process 700 for providing native RDP access to target resources, consistent with the disclosed embodiments. Similar to process 300 described above, process 700 may allow a client, such as client identity 110, to establish a remote desktop session with client system 120 for accessing target resource 128. As explained above, accessing the target resource 128 may include any operations by a client device involving data or information stored on target resource 128, such as reading, storing, deleting modifying, or any other forms of operations requiring access to the target resource. In some embodiments, access may be restricted to privileged client identities, as discussed above.

As indicated in FIG. 7, security agent 702 may identify a request 710 for an RDP connection with target resource 128. For example, identity 112 may launch a normal RDP session using a native client for example, by launching an mstsc client or a standard.rdp file. Security agent 702 may accept the local connection and become a broker for the session. In response to request 710, security agent 702 may initiate an outbound secure connection 720 to management agent 704, as shown in FIG. 7. Through this connection, security agent 702 may establish the outer TLS/HTTPS and RD Gateway tunnel setup needed for observation of the early setup flow.

As explained above, management agent 704 may be a component of client system 120 configured to perform various management tasks associated with enabling secure remote access sessions. For example, management agent 704 may be configured to authenticate security agent 702, perform an authentication of identity 112 (and/or client device 114), and provision various session details for configuring a remote desktop connection. In this example, management agent 704 may act as an RD Gateway, functioning as an intermediary or proxy for the requested connection.

As indicated in FIG. 7, security agent 702 may identify various information from request 710, including context information 722 and a requested target address 724 (which may correspond to target resource 128). Context information 722 may include any information associated with request 710 that may be relevant to validating or authenticating a session request. For example, context information 722 may include information identifying identity 112 and/or client device 114. Context information 722 may also include various metadata associated with request 710, such as a time of the request, a location of identity 112 (and/or client device 114), network properties (e.g., a network type, an IP address, etc.), device information (e.g., a manufacturer, a model number, a device identifier, etc.), a context of the request (e.g., other programs operating on client device 114), or any other relevant information.

During an initial “bootstrap” stage, security agent 702 may extract requested target address 724 from records associated with management agent 704. For example, management agent 704 may maintain a database of records associated with different target resources. Once an RDP ClientInfo structure becomes visible in the global channel, security agent 702 may identify the requested user context and the fields that must be replaced for management agent 704 to accept request 710. Security agent 702 may thus call management agent 704 using the detected context information 722 and requested target address 724, as shown in FIG. 7

Management agent 704 may then generate approved session parameters 732 in step 730. These session parameters 732 may be tailored specifically to request 710. Security agent 702 may then rewrite the RDP ClientInfo payload in flight in step 740. This may include modifying the payload using the approved session parameters 732 to generate modified session information 742. Security agent 702 may then forward modified session information 742 upstream to management agent 704, which may then route the authorized session to target resource 128 in step 750. After successful establishment, the security agent 702 may then transition into a transparent relay role for the remainder of the session. For example, security agent 702 may receive data from client device 114 and relay this data to target resource 128 via management agent 704 and vice versa. As a result, identity 112 may remotely access target resource 128 via a native RDP application. However, by incorporating security agent 702 the connection may nonetheless be managed through client system 120 in a manner that is transparent to identity 112.

As noted above, security agent 702 may similarly be configured to integrate with standard SSH client workflows as a local SSH-agent-compatible broker. For example, security agent 702 may make approved SSH access material available only when needed, keeping it in memory for short-lived use. Security agent 702 may support SSH authentication through a management agent 704 SSH Proxy in the cloud.

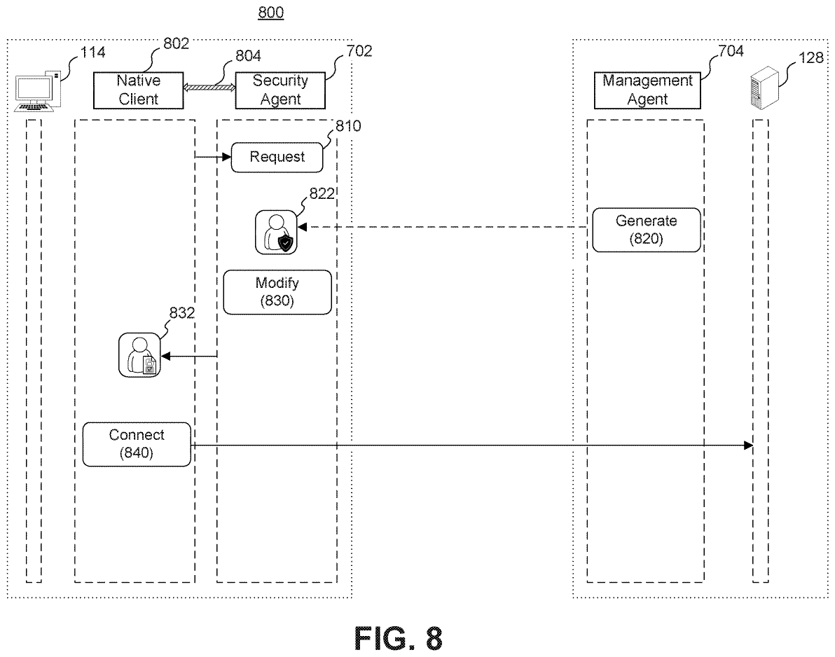

FIG. 8 is a block diagram illustrating an example process 800 for providing native SSH access to target resources, consistent with the disclosed embodiments. Similar to process 700 described above, process 800 may allow a client, such as client identity 110, to establish a remote desktop session with client system 120 for accessing target resource 128. This may likewise include operations such as reading, storing, deleting modifying, or any other forms of operations requiring access to target resource 128.

Similar to process 700, security agent 702 may identify a request 810 for a connection with target resource 128. In this example, however, identity 112 may initiate a standard SSH-based workflow through a native SSH client 802, such as PuTTY, OpenSSH, Terminus, MobaXterm, or similar clients. Native client 802 may interact with security agent 702 through a standard local SSH-agent-compatible mechanism, as indicated by connection 804. In this example, identity 112 may have an active authenticated session associated with client system 120. Security agent 702 may validate this session and obtain a validated credential 822 for identity 112. Consistent with the disclosed embodiments, validated credential 822 may be a short-lived SSH access credential. Accordingly, validated credential 822 may be a credential (e.g., a certificate, etc.) proving an identity of identity 112 for a short-lived window before automatically expiring.

Validated credential 822 may be maintained, at least temporarily, by security agent 702. Accordingly, in some embodiments, validated credential 822 may be obtained by retrieving the validated credential from a local storage of client device 114. Alternatively or additionally, where validated credential 822 has not yet been obtained, or where a previous validated credential has expired, security agent 702 may request validated credential 822 from management agent 704. As illustrated in FIG. 8, management agent 704 may generate validated credential 822 in step 820, which may be performed based on a current active session for identity 112.

Security agent 702 may then expose validated credential 822 to native agent 802. In some embodiments, this may include converting validated credential 822 into a format that is compatible with native agent 802. For example, security agent 702 may modify validated credential 822 in step 830 to generate modified credential 832, as shown. Native agent 802 may then proceed with connecting to target resource 128 through management agent 704 as indicated in step 840. For example, management agent 704 may route the session to target resource 128, which may be a Linux™, Unix™, or other form of network target. From a user perspective, identity 112 may experience a normal SSH workflow without manually handling separate keys or tokens associated with client system 120. When the local session ends or the temporary SSH artifact expires, security agent 702 may clear the local access state and remain ready for the next approved request.

In view of these techniques, security agent 702 enables secure, transparent RDP and SSH access by brokering sessions locally. Specifically, security agent 702 may obtain approved runtime session artifacts from client system 120, and may route traffic through the controlled client system 120 infrastructure. By implementing security agent 702 locally on client device 114, the disclosed techniques avoid requiring users, such as identity 112, to manually manage SSH keys, store sensitive access material in local workflow files, or work with tokenized RDP files.

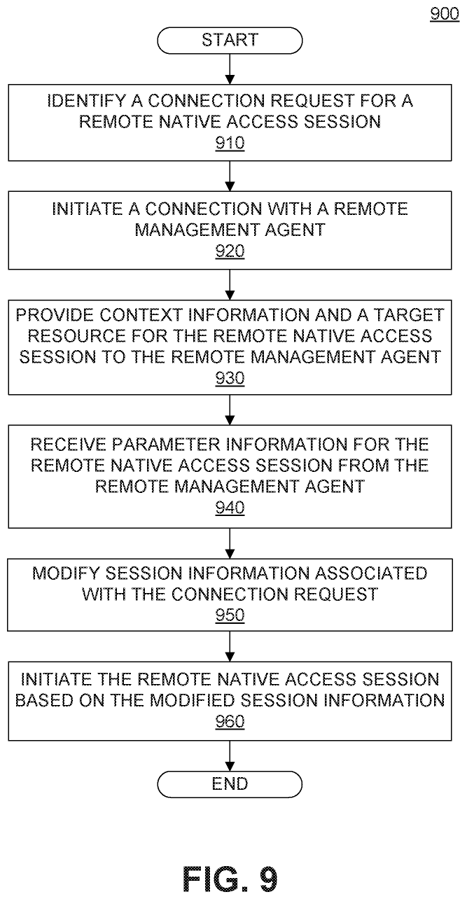

FIG. 9 is a flowchart illustrating an example process 900 for providing native RDP access to target resources by a local security agent, consistent with the disclosed embodiments. Process 900 may be performed by at least one processing device, such as processor 210 of security agent 702, as described above. In some embodiments, a non-transitory computer readable medium may contain instructions that when executed by a processor cause the processor to perform process 900. Further, process 900 is not necessarily limited to the steps shown in FIG. 9, and any steps or processes of the various embodiments described throughout the present disclosure may also be included in process 900, including those described above with respect to FIGS. 3, 5, 6, and 7.

In step 910, process 900 may include identifying a connection request for a remote native access session. For example, step 910 may include identifying request 710 by security agent 702, as described above. Accordingly, the connection request may be initiated by a native access client on a client machine, such as client device 114. Consistent with the disclosed embodiments, the request may be associated with a native remote desktop protocol. For example, the native access client may be a Microsoft™ Terminal Services Client (mstsc), or the connection request may include a remote access protocol file, such as a Remote Desktop Protocol connection file. Step 910 may further include accepting the connection request by the security agent.

In step 920, process 900 may include initiating a connection with a remote management agent. The remote management agent is implemented as a cloud-based agent, as explained above. For example, step 920 may include initiating secure connection 720 with management agent 704, as described above. This secure connection may enable the security agent to broker the early part of a standard desktop access flow, as described herein.

In step 930, process 900 may include providing context information and a target resource for the remote native access session to the remote management agent via the connection. For example, step 930 may include providing context information 722 and requested target address 724 to management agent 704, as described above. In some embodiments, process 900 may further include extracting the context information and the target resource by the security agent, which may be extracted the connection request. For example, security agent 702 may extract context information 722 and requested target address 724 from request 710.

In some embodiments, process 900 may further include extracting, by the security agent, a target address for the target resource from a data structure, which may be stored at the remote management agent. For example, process 900 may include extracting requested target address 724 from records associated with management agent 704.

In step 940, process 900 may include receiving, from the remote management agent, parameter information for the remote native access session. The parameter information may be generated by the remote management agent based on the context information and the target resource. For example, step 940 may include receiving approved session parameters 732 from management agent 704, as explained above.

In step 950, process 900 may include modifying session information associated with the connection request based on the received parameter information. For example, step 950 may include modifying session information using session parameters 732 to generate modified session information 742, as indicated in step 730 above. For example, security agent 702 may modify a Remote Desktop Protocol ClientInfo payload or other RDP information. In some embodiments, modifying the session information may include replacing the original session parameters in the session information with the received parameter information. The modified session information may be modified such that it will be accepted by the remote management agent based on the included parameter information. The remote management agent may thus be configured to route the remote native access session to the target resource based on the modified session information.

In step 960, process 900 may include initiating the remote native access session based on the modified session information. In some embodiments, initiating the remote native access session may include forwarding the modified session information to the remote management agent. The remote management agent may be configured to route the remote native access session to the target resource based on the modified session information. Once the session has been initiated, process 900 may further include relaying session information to the native access client during the remote native access session.

In some embodiments, process 900 may further enable various security measures to be implemented by the security agent. For example, process 900 may further include monitoring the remote native access session by the security agent. Based on this monitoring, the security agent may identify potentially malicious or otherwise unwanted activity and take a responsive action. For example, process 900 may further include performing a control action by the security agent based on an anomaly detected during the monitoring. The control action may include terminating the remote native access session, or various other actions, such as generating an alert, logging the detected anomaly, cycling a credential of identity 112, or the like.

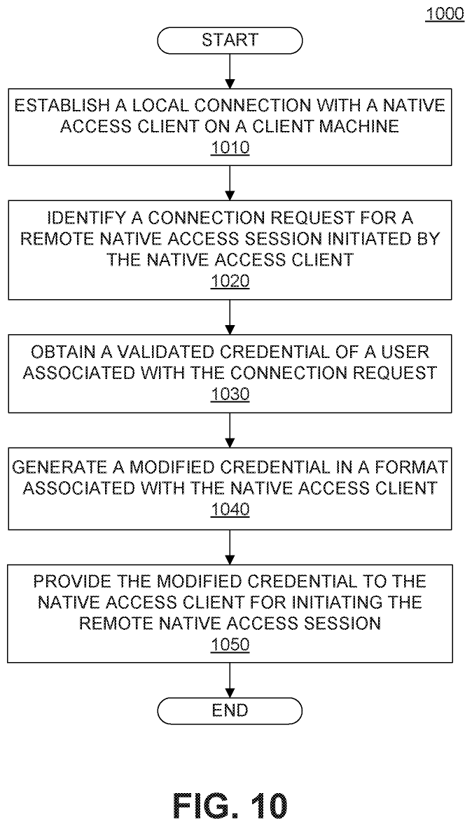

FIG. 10 is a flowchart illustrating an example process 1000 for providing native SSH access to target resources by a local security agent, consistent with the disclosed embodiments. Process 1000 may be performed by at least one processing device, such as processor 210 of security agent 702, as described above. In some embodiments, a non-transitory computer readable medium may contain instructions that when executed by a processor cause the processor to perform process 1000. Further, process 1000 is not necessarily limited to the steps shown in FIG. 10, and any steps or processes of the various embodiments described throughout the present disclosure may also be included in process 1000, including those described above with respect to FIGS. 3, 5, 6, 7, 8, and 9.

In step 1010, process 1000 may include establishing, by a security agent on a client machine, a local connection with a native access client on the client machine. For example, this may include establishing local connection 804 between native agent 802 and security agent 702, as described above. The native client may be any form of client associated with native SSH connections and thus may be a Secure Shell (SSH) client.

In step 1020, process 1000 may include identifying, via the local connection, a connection request for a remote native access session. For example, step 1020 may include identifying request 810 by security agent 702, as described above. The connection request may be initiated by the native access client. For example, the connection request may be initiated by the user using the client machine using the native access client.

In step 1030, process 1000 may include obtaining, based on the connection request, a validated credential of a user associated with the connection request. For example, step 1030 may include obtaining validated credential 822, as described above. Consistent with the present disclosure, the validated credential may have been received from a remote management agent, such as management agent 704. In some embodiments, the remote management agent may be implemented as a cloud-based agent. Process 1000 may further include verifying an active session for the user associated with the remote management agent.

In some embodiments, the remote management agent may have previously generated the validated credential. Accordingly, obtaining the validated credential may include retrieving the validated credential from a local storage. For example. The validated credential may have been stored in the local storage by the security agent during a prior remote native access session. As explained above, the local storage includes a storage device on the client machine, such as a local memory of client device 114.

Alternatively or additionally, obtaining the validated credential may include requesting the validated credential from the remote management agent. For example, the validated credential is associated with a time-based restriction. Once the validated credential expires, the security agent may be required to request a new credential from the remote management agent. The remote management agent may be configured to issue the validated credential based on an active session for the user associated with the remote management agent.

In step 1040, process 1000 may include generating a modified credential based on the validated credential. For example, step 1040 may correspond to step 830 described above and thus the modified credential may correspond to modified credential 832. As explained above, the modified credential may be in a format associated with the native access client. Accordingly, the native access client may be configured to initiate the remote native access session based on the modified credential.

In step 1050, process 1000 may include providing the modified credential to the native access client for initiating the remote native access session. For example, the native access client may be configured to initiate the remote native access session via a proxy agent associated with the remote management agent. The proxy agent may be configured to route the remote native access session to a target resource. In some embodiments, process 1000 may further include determining, by the security agent, that the validated credential has expired and terminating the remote native access session.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for securely establishing secretless and remote native access sessions, the operations comprising:
establishing, by a security agent on a client machine, a local connection with a native access client on the client machine;
identifying, via the local connection, a connection request for a remote native access session, the connection request being initiated by the native access client;
obtaining, based on the connection request, a validated credential of a user associated with the connection request, the validated credential having been received from a remote management agent;
generating a modified credential based on the validated credential, the modified credential being in a format associated with the native access client; and
providing the modified credential to the native access client for initiating the remote native access session.

2. The non-transitory computer readable medium of claim 1, wherein the operations further comprise verifying an active session for the user associated with the remote management agent.

3. The non-transitory computer readable medium of claim 1, wherein obtaining the validated credential includes retrieving the validated credential from a local storage.

4. The non-transitory computer readable medium of claim 3, wherein the local storage includes a storage device on the client machine.

5. The non-transitory computer readable medium of claim 3, wherein the validated credential was stored in the local storage by the security agent during a prior remote native access session.

6. The non-transitory computer readable medium of claim 1, wherein obtaining the validated credential includes requesting the validated credential from the remote management agent.

7. The non-transitory computer readable medium of claim 6, wherein the remote management agent is configured to issue the validated credential based on an active session for the user associated with the remote management agent.

8. The non-transitory computer readable medium of claim 1, wherein the validated credential is associated with a time-based restriction.

9. The non-transitory computer readable medium of claim 1, wherein the connection request is initiated by the user using the client machine.

10. The non-transitory computer readable medium of claim 1, wherein the native access client is a Secure Shell (SSH) client.

11. A computer-implemented method for securely establishing secretless and remote native access sessions, the method comprising:
establishing, by a security agent on a client machine, a local connection with a native access client on the client machine;
identifying, via the local connection, a connection request for a remote native access session, the connection request being initiated by the native access client;
obtaining, based on the connection request, a validated credential of a user associated with the connection request, the validated credential having been received from a remote management agent;
generating a modified credential based on the validated credential, the modified credential being in a format associated with the native access client; and
providing the modified credential to the native access client for initiating the remote native access session.

12. The computer-implemented method of claim 11, the method further comprising:
determining, by the security agent, that the validated credential has expired; and
terminating the remote native access session.

13. The computer-implemented method of claim 11, wherein the remote management agent is implemented as a cloud-based agent.

14. The computer-implemented method of claim 11, wherein the native access client is configured to initiate the remote native access session based on the modified credential.

15. The computer-implemented method of claim 11, wherein the native access client is configured to initiate the remote native access session via a proxy agent associated with the remote management agent.

16. The computer-implemented method of claim 15, wherein the proxy agent is configured to route the remote native access session to a target resource.

17. The computer-implemented method of claim 11, wherein obtaining the validated credential includes retrieving the validated credential from a local storage.

18. The computer-implemented method of claim 17, wherein the local storage includes a storage device on the client machine.

19. The computer-implemented method of claim 11, wherein obtaining the validated credential includes requesting the validated credential from the remote management agent.

20. The computer-implemented method of claim 19, wherein the remote management agent is configured to issue the validated credential based on an active session for the user associated with the remote management agent.
